(19) United States
(12) Patent Application Publication
(10) Pub. No.: US 2006/0024518 A1
(43) Pub. Date: Feb. 2, 2006

(54) Low density cavitated opaque polymer film

(76) Inventors: Dan-Cheng Kong, Fairport, NY (US); Etienne R.H. Lernoux, Pittsford, NY (US); Robert M. Sheppard, Victor, NY (US)

Correspondence Address: ExxonMobil Chemical Company;Law Technology, P.O. Box 2149, Baytown, TX, 77522-2149, US

(21) Appl. No.: 10/910,146

(22) Filed: Aug. 2, 2004

(51) Int. Cl. B32B 27/00; B32B 7/12

(52) U.S. Cl. 428/500; 428/343

(57) ABSTRACT

A low density opaque polymer film containing at least one layer having a propylene polymer matrix that has been cavitated by a two component cavitation system, wherein the first component of the two component cavitation system is a beta-nucleating agent to produce the beta-crystalline form of polypropylene, and the second component is filler. A method of manufacturing a low density cavitated opaque polymer film, including: forming a melt containing a propylene polymer, a beta nucleating agent and filler; cooling the melt to form a film layer; and stretching the film layer to form voids therein. The cavitated opaque film has a density falling within the range of 0.2 g/cm³ to 0.45 g/cm³.

### BACKGROUND OF THE INVENTION

The invention relates to a low density cavitated opaque polymer film. In particular, the invention relates to a polymer film having uniform opacity, low density and enhanced stiffness, the opaque polymer film having been cavitated via beta-nucleated (beta-crystalline) orientation in the presence of filler. The invention takes advantage of a previously unknown synergy between a beta-nucleating agent and filler to provide a low density cavitated opaque polymer. The low density cavitated opaque polymer film is especially suited for labeling applications.

The market for polymer films continues to expand. One area of growth is in the food and beverage industry. Polymer films are increasingly being used as labels in the food and beverage industry, in part due to their printability and their ability to conform and adhere to the surface of a food package or beverage container. The preferred label, however, is opaque and/or colored, e.g., a white opaque label. Polymer films, on the other hand, especially polyolefin films, are inherently clear and colorless. Therefore, polymer films to be used as labels are generally modified to render them opaque and/or colored.

A variety of techniques are known to modify a polymer film and render it opaque and/or colored.

For example, it is well-known in the art to include certain organic or inorganic cavitating agents in one or more layers of a polymer film. The organic cavitating agent may be a polyester, such as polyethylene terephthalate (PET) or polybutylene terephthalate (PBT). The inorganic cavitating agent may be calcium carbonate (CaCO₃). The presence of the cavitating agent in a layer of the film during orientation of the film induces voids in the polymeric material comprising the layer of the film. The voids scatter light thereby causing the film to be opaque.

U.S. Pat. No. 4,632,869 to Park, et al., discloses an opaque, biaxially oriented film structure containing a voided polymer matrix layer, in which the voids contain spherical void-initiating particles of polybutylene terephthalate (PBT). The structure may also include thermoplastic skin layers, and the individual layers may include pigments, such as TiO₂ or colored oxides.

However, the use of CaCO₃- or PBT-type cavitating agents to induce voids in a polymer film, as proposed by U.S. '869 and others like it, is an example of a single component cavitation method. Single component cavitation of this type tends to yield relatively large average pore sizes. As a result, the mechanical properties of the film suffer, leading to inferior resistance to permanent deformation, e.g., label wrinkling, label buckling, or label shrinkage, when the film is subjected to bending and creasing stresses.

In addition, single component cavitation of this type tends to yield a non-uniform void distribution due to filler dispersion problems. Furthermore, the cavitated films produced from single component cavitation of this type tend to have a density falling within the range of from greater than 0.45 g/cm³ to 0.90 g/cm³.

It is also known in the art to induce voids in a film layer containing polypropylene by including therein a beta-crystalline nucleating agent. The voids formed by this type of single component cavitation method tend to have a decreased average pore size.

There are three types of crystalline forms for polypropylene—alpha, beta, and gamma. The alpha-crystalline form of polypropylene has a monoclinic crystal structure. The beta-crystalline form of polypropylene has a hexagonal crystal structure. The gamma-crystalline form of polypropylene has a triclinic crystal structure. The gamma-crystalline form of polypropylene has the highest density, while the beta-crystalline form has the lowest density.

However, the gamma-crystalline form of polypropylene only grows under high pressure. In typical film processing conditions, the gamma-crystalline form is not observed. And between the alpha-crystalline and beta-crystalline forms, the alpha-crystalline form is the more stable crystalline form. Under typical film processing conditions, the majority of polypropylene will be the alpha-crystalline form. Therefore, a beta-crystalline nucleating agent is required in order to produce a significant amount of the beta-crystalline form of polypropylene during melt crystallization.

EP 0 865 909 of Davidson et al. discloses biaxially oriented, heat-shrinkable polyolefin films for use as labels, having a layer of a polypropylene-based resin with microvoids therein. The microvoids are formed by stretching a web containing the beta-crystalline form of polypropylene.

EP 0 865 910 and EP 0 865 912, both of Davidson et al., disclose biaxially oriented polyolefin opaque films having a thickness of not more than 50 μm and having a layer of a polypropylene-based resin with microvoids therein. The microvoids are formed by stretching a web containing the beta-crystalline form of polypropylene at an area stretch ratio of at least 15:1.

EP 0 865 911 of Davidson et al. discloses biaxially oriented polyolefin films containing a heat seal layer and a layer having microvoids formed therein by stretching the polypropylene-based resin of the layer, which contains the beta-crystalline form of polypropylene. The heat seal becomes transparent upon heating.

EP 0 865 913 of Davidson et al. discloses biaxially oriented, heat-shrinkable polyolefin films having a layer of a polypropylene-based resin with microvoids therein. The microvoids have been formed by stretching a web containing the beta-crystalline form of polypropylene. The film has a shrinkage after 10 minutes at 130° C of at least 10% in at least one direction.

EP 0 865 914 of Davidson et al. discloses biaxially oriented, high gloss polyolefin films having a layer of a polypropylene-based resin with microvoids therein and at least one olefin copolymer outer layer thereon. The microvoids have been formed by stretching a web containing the beta-crystalline form of polypropylene.

U.S. Pat. No. 6,444,301 to Davidson, et al. discloses polymeric films including a layer of propylene resin having microvoids therein, the microvoids having been formed by stretching a web containing the beta-form of polypropylene.

U.S. Pat. No. 5,594,070 to Jacoby, et al. discloses oriented microporous films prepared from polyolefin resin compositions comprising an ethylene-propylene block copolymer having an ethylene content of about 10 to about 50 wt. %, a propylene homopolymer or random propylene copolymer having up to about 10 wt. % of a comonomer of ethylene or an α-olefin of 4 to 8 carbon atoms, and components selected from a low molecular weight polypropylene, a beta-spherulite nucleating agent and an inorganic filler. The microporous films are said to have improved breathability, strength, toughness and break elongation. However, the films of Jacoby have a tendency to exhibit pink color when red dye (beta-spherulite nucleating agent) concentration is higher than 50 ppm. If the concentration of red dye (beta-spherulite nucleating agent) is lower than 50 ppm, then it is difficult to obtain consistent opacity due to poor dispersion uniformity.

However, films cavitated using only a beta-crystalline nucleating agent, such as films from the various Davidson publications noted above, are single component cavitated films.

### SUMMARY OF THE INVENTION

It is an object of the invention to provide a cavitated polymer film having uniform opacity, a low density and improved mechanical properties, e.g., enhanced stiffness.

It is also an object of the invention to provide a cavitated polymer film, which has uniform opacity, a low density and improved mechanical properties, that is economically advantageous.

It is additionally an object of the invention to provide a cavitated polymer film, which has uniform opacity, a low density and improved mechanical properties, that is particularly suited for labeling applications.

There is provided a low density opaque polymer film containing at least one layer having a propylene polymer matrix that has been cavitated by a two component cavitation system, wherein the first component of the two component cavitation system is a beta-nucleating agent to produce the beta-crystalline form of polypropylene, and the second component is filler.

In particular, there is provided a low density cavitated opaque polymer film, comprising at least one layer comprising a propylene polymer, a beta nucleating agent, and filler.

There is also provided a low density cavitated opaque film comprising: a core layer comprising a propylene polymer, a beta nucleating agent, and filler; and at least a first outer layer on one side of the core layer, the first outer layer comprising a thermoplastic polymer.

There is furthermore provided a method of manufacturing a low density cavitated opaque polymer film, comprising forming a melt comprising a propylene polymer, a beta nucleating agent and filler; cooling the melt to form a film layer; and stretching the film layer to form voids therein.

The invention takes advantage of a previously unknown synergy between the beta-nucleating agent and the filler to provide a cavitated opaque film having a density falling within the range of 0.20 g/cm³ to 0.45 g/cm³.

### DETAILED DESCRIPTION OF THE INVENTION

“Core layer” as used herein refers to the only layer of a monolayered film or the thickest layer of a multilayered film. In general, the core layer of a multilayer structure will be the innermost, central layer of the structure.

It will be understood that when a layer is referred to as being “directly on” another layer, no intervening layers are present. On the other hand, when a layer is referred to as being “on” another layer, intervening layers may or may not be present.

The low density cavitated opaque polymer film comprises a core layer.

The core layer comprises a polymeric matrix comprising a propylene polymer. The term “propylene polymer” as used herein includes homopolymers as well as copolymers of propylene, wherein a copolymer not only includes polymers of propylene and another monomer, but also terpolymers, etc. Preferably, however, the propylene polymer is a propylene homopolymer.

The propylene polymer of the core layer preferably has an isotacticity ranging from about 80 to 100%, preferably greater than 84%, most preferably from about 85 to 99%, as measured by ¹³C NMR spectroscopy using meso pentads. A mixture of isotactic propylene polymers may be used. Preferably, the mixture comprises at least two propylene polymers having different m-pentads. Preferably, the difference between m-pentads is at least 1%. Furthermore, the propylene polymer of the core layer preferably has a melt index ranging from about 2 to about 10 g/10 minutes, most preferably from about 3 to about 6 g/10 minutes, as measured according to ASTM D1238 at 190° C. under a load of 5 lbs.

Commercially available propylene polymers for the core layer include ATOFINA 3371, which is an isotactic polypropylene homopolymer sold by ATOFINA Petrochemicals, Inc., and XOM 4612, an isotactic propylene homopolymer, available from ExxonMobil Chemical Company (Houston, Tex.).

The core layer also comprises a beta-crystalline nucleating agent. Any beta-crystalline nucleating agent (“beta nucleating agent” or “beta nucleator”) may be used.

U.S. Pat. No. 4,386,129 to Jacoby and U.S. Pat. No. 4,975,469 to Jacoby disclose processes of forming a film containing nucleating agents to produce beta-form spherulites and then selectively extracting the beta-spherulites. Both Jacoby patents disclose quinacridone compounds, bisodium salts of o-phthalic acids, aluminum salts of 6-quinizarin sulfonic acid and isophthalic and terephthalic acids as beta nucleating agents.

U.S. Pat. No. 5,681,922 to Wolfschwenger, et al. discloses the use of dicarboxylic acid salts of metals of the second main group of the Periodic Table as beta nucleating agents.

A two component beta nucleator may be used as the beta nucleating agent of the invention. For example, U.S. Pat. No. 5,231,126 to Shi, et al. discloses the use of a mixture of a dibasic organic acid and an oxide, hydroxide or salt of a metal of group IIA of the Periodic Table. A two component beta nucleator is not to be confused with the two component cavitation method of the invention. A two component beta nucleator still makes up only one component of the present two component cavitation method for producing the cavitated opaque polymer films of the invention.

U.S. Pat. No. 5,491,188, U.S. Pat. No. 6,235,823, and EP 0 632 095, each of Ikeda, et al., disclose the use of certain types of amide compounds as beta nucleators.

U.S. Pat. No. 6,005,034 to Hayashida, et al. discloses various types of beta nucleators.

U.S. Pat. Nos. 4,386,129; 4,975,469; 5,681,922; 5,231,126; 5,491,188; 6,235,823; 6,005,034; as well as EP 0632095, are herein incorporated by reference.

Preferably, the beta-nucleating agent is a two component beta nucleator formed by the mixing of Components A and B. Component A is an organic dibasic acid, such as pimelic acid, azelaic acid, o-phthalic acid, terephthalic and isophthalic acid and the like. Component B is an oxide, hydroxide or an acid salt of a Group II metal, e.g., magnesium, calcium, strontium and barium. The acid salt of Component B may come from inorganic or organic acid such as carbonate, stearate, etc. Component B may also be one of the additives of polypropylene, that already is present in the polypropylene material. The proportion of Component A may be in the range of 0.0001-5% by weight, based on the total weight of polypropylene, most preferably 0.01-1 wt. %, whereas the proportion of Component B is 0.0002-5% by weight, based on the total weight of polypropylene, most preferably 0.05-1%, during mixing.

Preferably, the beta-nucleating agent is not a red dye.

Preferably, the propylene polymer and beta nucleating agent are brought together to form the core layer via a masterbatch.

For example, in some embodiments, the core layer may comprise Bepol 022SP, a masterbatch of isotactic propylene homopolymer and beta-nucleating agent, available from Sunoco Chemicals. In other embodiments, the core layer may comprise an impact propylene copolymer masterbatch with a beta crystal nucleator of polypropylene or the core layer may comprise an impact propylene copolymer masterbatch with a beta crystal nucleator of polypropylene and an isotactic polypropylene. In still other embodiments, the core layer may comprise: an (isotactic propylene)-ethylene heterophasic copolymer masterbatch with a beta crystal nucleator of polypropylene and an isotactic polypropylene; an impact polypropylene masterbatch with a beta crystal nucleator of polypropylene and a metallocene isotactic polypropylene; or an (isotactic propylene)-ethylene heterophasic copolymer, ethylene-propylene-ethylidene norbornene elastomer, isotactic polypropylene masterbatch with a beta crystal nucleator of polypropylene and an isotactic polypropylene that has a different m-pentad than the isotactic polypropylene in the isotactic polypropylene masterbatch.

One type of impact copolymer which may be used in the invention comprises a polymer matrix with a dispersed rubbery copolymer phase. The matrix is a homopolymer or random copolymer matrix. The rubbery copolymer phase is a reactor blend of an amorphous rubber, a rubber-like polymer, which is normally an ethylene-propylene copolymer (rubber), and a semicrystalline ethylene copolymer.

By mixing the propylene polymer of the core layer, which predominantly contains the alpha-crystalline form of polypropylene, with the beta nucleating agent of the core layer, high concentrations of the beta-crystalline form of polypropylene are induced after the melting and subsequent cooling steps of the film-making process. The beta-crystalline form of polypropylene has a lower melting point and a lower density than the common alpha-crystalline form of polypropylene.

The core layer furthermore comprises a filler. Preferably, the filler is an inorganic filler. Most preferably, the filler is selected from the group consisting of calcium carbonate (CaCO₃), barium carbonate (BaCO₃), clay, talc, silica, mica, titanium dioxide (TiO₂), and mixtures thereof.

Preferably, the filler is not an organic filler. Organic fillers tend to plate-out, which results in manufacturing downtime. Also, the cavitation quality from the use of organic fillers is sensitive to the viscosity change from the polypropylene reclaims and output rate variations.

The amount of filler to be included in the core layer may range from 2 to 35 wt. %, based on the total weight of the core layer. Preferably, the core layer contains from 5 to 30 wt. % of filler, most preferably from 7 to 20 wt. %.

The amount of beta nucleator to be included in the core layer should be enough to obtain the desired degree of void formation upon stretching. The amount of beta nucleators may also be used to control the degree of opacity. Preferred amounts of beta nucleators are from 0.0002 to 8 wt. % based on the weight of polypropylene, more preferably 0.005 to 2 wt. %, and 0.01 to 2 wt. %.

Generally, the remainder of the core layer is made up of the propylene polymer(s) mentioned above, after the filler, beta nucleator, and any optional additives have been taken into account.

The core layer thickness is preferably at least 70% of the whole film thickness.

The invention provides multilayer film structures wherein another layer or layers besides the core layer has been cavitated via the two-component cavitation method of the invention. For example, another layer or layers of a multilayer film structure according to this invention may comprise each of the same components as the core layer.

In addition, the invention provides multilayer film structures comprising a core layer comprising a polymeric matrix comprising a propylene polymer, a beta nucleating agent, and filler, and at least a first outer layer on one side of the core layer. The first outer layer may be provided on or directly on a side of the core layer.

The first outer layer may comprise a polymeric matrix comprising any of the film-forming thermoplastic polymers. Examples of suitable film-forming thermoplastic polymers include the polyolefins, such as propylene polymers and ethylene polymers.

In certain embodiments, the first outer layer will be a sealable outer layer, such as a heat-sealable outer layer. For example, the first outer layer may comprise a propylene-ethylene copolymer, propylene-ethylene-butene-1 terpolymer (such as XPM7510, an ethylene-propylene-butene-1 terpolymer, available from Chisso Company, Japan), propylene-α-olefin copolymer, or metallocene-catalyzed ethylene-α-olefin copolymer.

In other embodiments, the first outer layer is a sealable outer layer comprising a polymer selected from the group consisting of an (isotactic propylene)-α-olefin copolymer, a (syndiotactic propylene)-α-olefin copolymer, an ethylene-vinyl acetate copolymer (EVA), an ethylene-methacrylic acid copolymer (EMA), an ethylene-acrylic acid copolymer (EAA), an ethylene-methylacrylate-acrylic acid terpolymer (EMAAA), an ethylene-alkyl acrylate copolymer, an ionomer such as ethylene-alkyl acrylate-acrylic acid Zn salt or Na salt, a metallocene-catalyzed plastomer, a very low density polyethylene (VLDPE), for example, having a density of 0.89 to 0.915 g/cc, an ethylene-(methyl acrylate)-(glycidyl methacrylate) terpolymer, and an ethylene-(glycidyl methacrylate) copolymer.

In still other embodiments, the first outer layer is not sealable. For example, the first outer layer may comprise isotactic propylene homopolymer, syndiotactic propylene homopolymer, isotactic propylene impact copolymer, syndiotactic propylene impact copolymer, propylene homopolymer with beta-nucleator additive, and propylene impact copolymer with beta-nucleator additive. For example, the impact copolymer may be TI-4040-G, an impact propylene copolymer available from Sunoco. TI-4040-G contains 17% ethylene-propylene rubber content.

The first outer layer may also comprise mixtures of any of the foregoing polymers.

As mentioned, the first outer layer may be provided directly on a side of the core layer or on a side of the core layer with one or more intermediate layers therebetween.

An intermediate, or tie, layer of the invention may comprise a polymeric matrix comprising any of the film-forming polymers. Suitable film-forming polymers for forming the polymeric matrix of the optional intermediate layer(s) include polyolefins, such as polypropylene, syndiotactic polypropylene, polypropylene copolymers, low density polyethylene (LDPE), linear low density polyethylene (LLDPE), medium density polyethylene (MDPE), high density polyethylene (HDPE), ethylene copolymers, nylons, polymers grafted with functional groups, blends of these, etc. For example, an intermediate layer may comprise a polyolefin grafted with a functional group, such as ADMER 1179, a maleic anhydride-grafted polypropylene available from Mitsui Petrochemical Industries Ltd. (Tokyo, Japan).

In particular embodiments, there is provided a second outer layer on a side of the core layer opposite the first outer layer.

The second outer layer also comprises a polymeric matrix comprising any of the film-forming thermoplastic polymers. As with the first outer layer, examples of suitable film-forming thermoplastic polymers for the second outer layer include the polyolefins, such as propylene and ethylene polymers or copolymers. For example, the film-forming material for the second outer layer may be independently selected from the same film-forming materials noted above for the first outer layer.

As with the first outer layer, the second outer layer may be provided directly on the side of the core layer or on the side of the core layer with one or more intermediate layers therebetween. The intermediate layer between the core layer and second outer layer may comprise a polymeric matrix comprising any of the film-forming polymers. For example, the film-forming material for an intermediate layer between the core layer and second outer layer may be independently selected from the same film-forming materials noted above for an intermediate layer between the core layer and first outer layer.

One or both outer surfaces of the overall film structure may be surface-treated. In the case of a monolayer structure, the outer surfaces of the structure would simply be the outer surfaces of the core layer. If the structure consists of a core layer and first outer layer, the outer surfaces would be the surface of the first outer layer opposite the core layer and the surface of the core layer opposite the first outer layer. If the structure contains a core layer and at least first and second outer layers, the outer surfaces would be the surfaces of the first and second outer layers that are respectively opposite the core layer.

The surface-treatment may be effected by any of various techniques, including, for example, flame treatment, corona treatment, and plasma treatment. In certain embodiments, the outer surface or surfaces may even be metallized. Metallization can be effected by vacuum deposition, or any other metallization technique, such as electroplating or sputtering. The metal may be aluminum, or any other metal capable of being vacuum deposited, electroplated, or sputtered, such as, gold, silver, zinc, copper, or iron.

One or both outer surfaces of the overall film structure may be coated with a coating, such as a primer coating, e.g., a polyvinylidene chloride (PVdC), acrylic, or silicon oxide (SiOₓ) coating, a water-based coating, or a coating comprising inorganic particles, such as clay, calcium carbonate, or titanium oxide, dispersed in a binder, such as an iminated butyl acrylate copolymer. Coatings may be used to provide advantages such as enhanced gloss and enhanced compatibility with manufacturing processes and machinery. In certain embodiments, priming the first outer layer can render it more receptive to printing.

In order to modify or enhance certain properties of the overall film structure, it is possible for one or more of the layers to contain dispersed within their respective matrices appropriate additives in effective amounts. Preferred additives include anti-blocks, anti-static agents, anti-oxidants, anti-condensing agents, co-efficient of friction (COF) modifiers (slip agents), processing aids, colorants, clarifiers, foaming agents, flame retardants, photodegradable agents, UV sensitizers or UV blocking agents, crosslinking agents, ionomers and any other additives known to those skilled in the art.

For example, in certain embodiments, it may be desirable to include a coloring agent, such as a pigment or dye, in one or more of the layers, including the first outer layer or the tie layer between the core layer and first outer layer.

As another example, in certain embodiments, and especially certain label embodiments, the polymer matrix of an outer layer may include dispersed therein one or more anti-block agents to prevent “grabbing” of the label on machine surfaces, one or more slip agents to provide better slip on heated metal surfaces, and/or one or more anti-static agents to maximize sheetability. Specific examples of anti-block agents include coated silica, uncoated silica and crosslinked silicone. Specific examples of slip agents include silicone oils. Specific examples of anti-static agents include alkali metal sulfonates, tertiary amines and the like.

The invention provides multilayer film structures that have been tailored for label applications. A preferred label structure comprises a core layer comprising a polymeric matrix comprising a propylene polymer, a beta nucleating agent, and filler, and first and second outer layers. The first and second outer layers may be provided directly on the core layer and/or directly on an intermediate layer, on the respective sides of the core layer.

Preferably, a label according to the invention will comprise an adhesive provided on an outer surface of the first or second outer layer. The type of adhesive to be employed is not particularly limited. As an example, the adhesive may be a water-based adhesive, such as a cold glue adhesive or a polyvinylidene chloride latex. Cold glue adhesives are natural or synthetic adhesives, such as Henkel 7302, available from Henkel Adhesives, or OC 363-20, available from O.C. Adhesives Corp. The adhesive may alternatively be a pressure-sensitive adhesive. Adhesives suitable for labels are well-known in the art.

There is also provided a method of manufacturing a low density cavitated opaque polymer film. For example, a melt(s) corresponding to the individual layer(s) of the film structure may be prepared. The melts may be cast-extruded or coextruded into a sheet using a flat die or blown-extruded or coextruded using a tubular die. The sheets may then be oriented either uniaxially or biaxially by known stretching techniques. For example, the sheet may be uniaxially oriented from four to eight times of orientation ratio.

While the films may be made by any method, preferably the films are made by coextrusion and biaxial stretching of the layer(s). The biaxial orientation may be accomplished by either sequential or simultaneous orientation, as is known in the art. In particularly preferred embodiments, the film structure is oriented from four to six times in the machine direction and from four to ten times in the transverse direction.

During the manufacturing process, if the cast temperature is set too low, i.e., quick quenching, the alpha crystalline form will dominate and the beta-crystalline form will be in the minority. Therefore, films according to the invention are preferably manufactured by setting the cast roll temperature at above 85° C., more preferably from 90° C. to 100° C. The nip roll against the cast roll is preferably set to a range of from 93° C. to 120° C. At these settings, beta-crystalline formation is maximized. Though the films can be cast with or without a waterbath, preferably the film is cast without a waterbath.

In comparison to single component cavitated films, the beta-nucleated and filler two component cavitated films of the invention have a low density of from 0.20 to 0.45 g/cm³, preferably from 0.25 to 0.45 g/cm³, more preferably from 0.25 to 0.40 g/cm³.

The film density values reported herein were measured by a method of first measuring the yield of the film. Specifically, 80 pieces of film from a film sample are cut, each having a diameter of 4 inches (10.16 cm). The total area of the 80 pieces is then calculated. The weight of the 80 pieces (in grams) is then measured. The yield of the film (cm²/gram) will equal the total specimen area (cm²) over the specimen weight (gram).

After measuring the film yield, the film thickness is measured with a laser beam. In particular, the film thickness (mil) is measured with a Model 238-20, available from Beta LaserMike Company. The thickness unit value is converted from mils to centimeters. This non-contact method for measuring film thickness is especially suited for microvoided film because it avoids the error that arises from mechanical compression on the film from a conventional micrometer.

Finally, the density (gram/cm³) is calculated from the inverse (1/X) of the film yield (cm²/gram) times the film thickness (cm).

The two component-cavitated films of the invention have more uniform opacity in comparison to single-component cavitated films. Preferably, the light transmission of the film, as measured by ASTM D1003, is less than 35%, more preferably less than 30%, and most preferably less than 25%.

Films according to the invention are ideal for label applications, including cut & stack labeling, patch, and pressure-sensitive adhesive labeling. Their excellent stiffness allows them to endure any labeling and bottling application.

The low density films of the invention can be used as a label facestock laminated to a silicone release liner with pressure-sensitive adhesive. The pressure-sensitive label stock can be run through a die-cutter to produce labels affixed to a continuous release liner. The low density films can also be used as cut & stack labeling to replace paper-based labels. Traditional cut & stack labels are paper labels using hot melt or cold glue to adhere on glass or plastic containers.

The low density films of the invention may also be used with particular advantage for the manufacture of opaque packages for various materials, such as light-sensitive foodstuffs, particularly where moisture permeability is desired. Additionally, the films may be used for other packaging purposes where opaque polymeric films are required. Due to the high gas and moisture transmission rates of the low density films, they may be used for medical applications, where breathable films are required.

In general, the films of the invention can be useful for any thick film application that requires superior stiffness.

Total thickness of a film according to the invention is not particularly limited. For certain applications, the overall thickness should be greater than 20 μm for poly-gauge. Preferably, the film has an overall thickness of 30 μm to 110 μm for poly-gauge. Preferably, the thickness of each layer, as measured for the poly-gauge, ranges from 24 μm to 80 μm for the core layer; from 0.5 μm to 5 μm for the first outer layer (if present); from 0.5 μm to 5 μm for the second outer layer (if present); and from 2.5 μm to 10 μm for an intermediate layer (if present).

The present invention will be further described with reference to the following nonlimiting examples. For each example, the thickness values represent poly-gauge thickness.

### EXAMPLE 1

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 65 wt. % XOM 4612 + 25 wt. % Bepol |
| | 022SP + 10 wt. % HDPE/CaCO₃ |
| | masterbatch (60 wt. % CaCO₃ |
| | concentration); 37.5 μm |
| Second layer | TI4040G; 2.5 μm |

The film of Example 1 had a light transmission of about 7.1% and a film density of about 0.358 g/cm³.

### EXAMPLE 2

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 75 wt. % XOM 4612 + 15 wt. % Bepol |
| | 022SP + 10 wt. % PP/CaCO₃ |
| | masterbatch (70 wt. % CaCO₃ |
| | concentration); 37.5 μm |
| Second layer | TI4040G; 2.5 μm |

The film of Example 2 had a light transmission of about 7.5% and a film density of about 0.362 g/cm³.

### EXAMPLE 3

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 55 wt. % XOM 4612 + 25 wt. % Bepol |
| | 022SP + 20 wt. % PP/CaCO₃ |
| | masterbatch (70 wt. % CaCO₃ |
| | concentration); 40 μm |
| Second layer | TI4040G; 2.5 μm |

The film of Example 3 had a light transmission of about 5.4% and a film density of about 0.304 g/cm³.

### EXAMPLE 4

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 45 wt. % XOM 4612 + 25 wt. % Bepol |
| | 022SP + 30 wt. % PP/CaCO₃ |
| | masterbatch (70 wt. % CaCO₃ |
| | concentration); 45 μm |
| Second layer | TI4040G; 2.5 μm |

The film of Example 4 had a light transmission of about 4.3% and a film density of about 0.270 g/cm³.

### COMPARATIVE EXAMPLE A

A three layer opaque film is cast, with waterbath, at 38° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 85 wt. % XOM 4612 + 15 wt. % |
| | HDPE/CaCO₃ masterbatch (60 wt. % |
| | CaCO₃ concentration); 37.5 μm |
| Second layer | TI4040G; 2.5 μm |

The film of this comparative example had a light transmission of about 21.0% and a film density of about 0.555 g/cm³. Conventional polypropylene (without a beta-nucleating additive) is typically cast at around 38° C. with a waterbath in order to facilitate orientation.

### COMPARATIVE EXAMPLE B

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | XOM 4712; 2.5 μm |
| Core layer | 85 wt. % XOM 4612 + 15 wt. % Bepol |
| | 022SP; 32 μm |
| Second layer | XOM 4712; 2.5 μm |

Thus, the core layer of this comparative film had beta-nucleating agent but no filler, e.g., no CaCO₃. This comparative film had a light transmission of about 16.7% and a film density of about 0.56 g/cm³.

### EXAMPLE 5

A three layer opaque film is cast, without waterbath, at 93° C. and oriented via tenter-frame sequential orientation at five times in the MD and eight times in the TD. The film had an A/B/C structure, as follows:

| | |
|---|---|
| First outer layer | XPM7510; 2.5 μm |
| Core layer | 50 wt. % XOM 4612 + 20 wt. % Bepol |
| | 022SP + 30 wt. % PP/CaCO₃ |
| | masterbatch (70 wt. % CaCO₃ |
| | concentration); 42 μm |
| Second layer | XOM 4712; 2.5 μm |

XOM 4712 is a propylene homopolymer, available from ExxonMobil Chemical Company.

The film of Example 5 had a film density of about 0.280 g/cm³.

The film was used as a label facestock by laminating it to a release liner with a water-based pressure-sensitive adhesive. In particular, the second outer layer was coated with the pressure-sensitive adhesive, which contacted the silicone surface of the release liner after lamination. The laminated label stock was run through a label-converting machine to make labels.

### EXAMPLE 6

A cold glue coating, Henkel 7302, was applied to the film from Example 1, and the film with cold glue thereon was applied onto a beer bottle. The Henkel 7302 cold glue coating was applied on the outside surface of the second outer layer.

### EXAMPLE 7

The outer surface of the second layer of the film of Example 2 was vacuum-metallized with aluminum and used as a metallized-paper replacement.

### EXAMPLE 8

The outer surfaces of the first and second layers of the film of Example 4 were coated with a coating comprising clay particles dispersed in an iminated butyl acrylate copolymer at a coating weight of 2.6 g/m². The coated film was converted into cut-and-stack labels with a guillotine machine.

While the invention has been described in detail and with reference to specific embodiments thereof, it will be apparent to one of ordinary skill in the art that various changes and modifications can be made therein without departing from the spirit and scope of the invention. The Examples recited herein are demonstrative only and are not meant to be limiting.

What is claimed is:

1. A cavitated opaque film, comprising:
a core layer comprising a propylene polymer, a beta nucleating agent, and filler;
wherein the film has a density of from 0.20 g/cm³ to 0.45 g/cm³.

2. The cavitated opaque film of claim 1, wherein the propylene polymer of the core layer is selected from the group consisting of isotactic propylene homopolymer, isotactic propylene impact copolymer, isotactic propylene heterophasic copolymer, and mixtures thereof.

3. The cavitated opaque film of claim 2, wherein the propylene polymer is an isotactic propylene homopolymer having an m-pentad fraction of from 85% to 99%, as measured by ¹³C NMR spectroscopy.

4. The cavitated opaque film of claim 1, wherein the propylene polymer of the core layer is a mixture of at least two isotactic propylene homopolymers having different m-pentad fractions.

5. The cavitated opaque film of claim 1, further comprising a first outer layer on one side of the core layer, the first outer layer comprising a thermoplastic polymer.

6. The cavitated opaque film of claim 5, wherein the thermoplastic polymer of the first outer layer is selected from the group consisting of an isotactic propylene polymer, a syndiotactic propylene polymer, a propylene impact copolymer, a propylene-α-olefin copolymer, an ethylene-propylene-butene-1 terpolymer, a metallocene-catalyzed plastomer, an ethylene-vinyl acetate copolymer (EVA), an ethylene-methacrylic acid copolymer (EMA), an ethylene-acrylic acid copolymer (EAA), an ethylene methylacrylate acrylic acid terpolymer (EMAAA), an ethylene alkyl acrylic copolymer, an ionomer, a metallocene plastomer, a very low density polyethylene (VLDPE) having a density of 0.89 to 0.915 g/cm³, an ethylene-methyl acrylate-glycidyl methacrylate terpolymer, and an ethylene-(glycidyl methacrylate) copolymer.

7. The cavitated opaque film of claim 5, further comprising a second outer layer on a side of the core layer opposite the first outer layer, the second outer layer comprising a thermoplastic polymer.

8. The cavitated opaque film of claim 7, wherein the thermoplastic polymer of the second outer layer is selected from the group consisting of isotactic propylene homopolymer, syndiotactic propylene polymer, isotactic propylene impact copolymer, isotactic propylene copolymer, and mixtures thereof.

9. A label, comprising a pressure-sensitive adhesive coating on an outer surface of the cavitated opaque film of claim 8.

10. A label, comprising a cold glue adhesive on an outer surface of the cavitated opaque film of claim 8.

11. The cavitated opaque film of claim 7, wherein the second outer layer further comprises a beta nucleating agent.

12. The cavitated opaque film of claim 7, further comprising one or more intermediate layers between the core layer and second outer layer.

13. The cavitated opaque film of claim 7, wherein the outer surface of the second outer layer has been metallized.

14. The cavitated opaque film of claim 7, wherein at least one outer surface of the cavitated opaque film has a coating thereon.

15. The cavitated opaque film of claim 5, further comprising one or more intermediate layers between the core layer and first outer layer.

16. The cavitated opaque film of claim 15, wherein the first outer layer is directly on a first intermediate layer, the first intermediate layer is directly on the core layer, and the first intermediate layer has the same composition as the core layer.

17. The cavitated opaque film of claim 1, wherein the film has a density of from 0.25 g/cm³ to 0.45 g/cm³.

18. The cavitated opaque film of claim 17, wherein the film has a density of from 0.25 g/cm³ to 0.40 g/cm³.

19. The cavitated opaque film of claim 1, wherein the beta nucleating agent is a two component beta nucleating agent, the first component of the beta nucleating agent being selected from the group consisting of pimelic acid, azelaic acid, o-phthalic acid, terephthalic acid, and isophthalic acid, and the second component of the beta nucleating agent being selected from the group consisting of an oxide, a hydroxide, and an acid salt of a Group II metal.

20. The cavitated opaque film of claim 1, wherein the filler is an inorganic filler.

21. The cavitated opaque film of claim 20, wherein the inorganic filler is selected from the group consisting of CaCO₃, BaCO₃, clay, talc, silica, mica, TiO₂, and mixtures thereof.

22. The cavitated opaque film of claim 1, wherein the core layer comprises from 2 wt. % to 35 wt. % of filler, based on the total weight of the core layer.

23. The cavitated opaque film of claim 1, wherein the film has been uniaxially oriented from four to eight times of orientation ratio.

24. The cavitated opaque film of claim 1, wherein the film has been biaxially oriented from 4 to 6 times in the machine direction and from 4 to 10 times in the transverse direction.

25. A label, comprising a pressure-sensitive adhesive coating on an outer surface of the cavitated opaque film of claim 1.

26. A label, comprising a cold glue adhesive on an outer surface of the cavitated opaque film of claim 1.

27. A label, comprising a hot melt adhesive on an outer surface of the cavitated opaque film of claim 1.
